(19) United States
(12) Patent Application Publication
(10) Pub. No.: US 2011/0295861 A1
(43) Pub. Date: Dec. 1, 2011

(54) SEARCHING USING TAXONOMY

(75) Inventor: Randy W. Lacasse, Fairfax Station, VA (US)

(73) Assignee: CPA GLOBAL PATENT RESEARCH LIMITED, St. Helier (JE)

(21) Appl. No.: 12/787,748

(22) Filed: May 26, 2010

(51) Int. Cl. G06F 17/30

(52) U.S. Cl. 707/749; 707/777; 707/E17.008; 707/E17.069

(57) ABSTRACT

A technique is provided for processing search results. The technique includes executing a search based on a user input entered via a graphical user interface using a processor, identifying relevant documents based on the search, and obtaining a standard classification for each relevant document. The standard classification is a classification within a standard classification system. The technique also includes reclassifying each relevant document, based on the relevant document's standard classification, into an interpretive classification within an interpretive classification system. The interpretive classification comprises at least a primary class and a secondary class. The technique further includes grouping the relevant documents into each relevant document's primary class and secondary class, and displaying the primary classes of the relevant documents and a number of relevant documents grouped in each displayed primary class via the graphical user interface on a display device.

### FIELD OF THE DISCLOSURE

This generally relates to techniques and systems for providing search capabilities and presentation and analysis of search results using classifications.

### BACKGROUND

Patent applications submitted for examination before the U.S. Patent and Trademark Office must meet certain requirements in order to issue as patents. For example, the subject matter claimed in the patent applications must be deemed new, useful, and non-obvious. Similar standards are applied in patent offices of most, if not all, foreign patent offices. To more effectively prepare a patent application for examination, it is useful to have knowledge of prior art, including prior patent documents (e.g., patents and published patent applications) in related areas of technology since only one patent may be granted per invention. Conducting a patent search can be one way in which prior art can be ascertained. The results of the patent search can help the drafter of a patent application to focus on aspects that appear to be patentable subject matter and aid in developing a reasonable strategy for achieving the goals of the inventor or owner of the patent rights.

Prior to the evolution of technology in the current electronic information age, patent searches were conducted manually. A skilled searcher would review a patent disclosure and conduct a paper search based on a patent classification system. With the advent of information technology, paper search has given way to electronic search since most patents and published patent applications are available in electronic form. Unfortunately, although electronic search tools can provide search results much faster than a paper search, existing tools can impede efficiency by not facilitating efficient perusal of search results. Also, with the ubiquity of electronic searching, the number of non-professional, less-skilled searchers has increased. Consequently, many searchers are not familiar with the intricacies of existing patent classification systems.

### SUMMARY

This relates to a search platform that can facilitate efficient and intuitive perusal and analysis of search results. Additionally, the search platform can enable the user to easily narrow a result set of documents to focus on more relevant documents.

Briefly, in accordance with one aspect of the present technique, a method is provided for processing search results. The method provides for executing a search based on a user input entered via a graphical user interface using a processor, identifying relevant documents based on the search, and obtaining a standard classification for each relevant document. The standard classification is a classification within a standard classification system. The method also provides for reclassifying each relevant document, based on the relevant document's standard classification, into an interpretive classification within an interpretive classification system. The interpretive classification comprises at least a primary class and a secondary class. The method further provides for grouping the relevant documents into each relevant document's primary class and secondary class, and displaying the primary classes of the relevant documents and a number of relevant documents grouped in each displayed primary class via the graphical user interface on a display device.

In accordance with another aspect of the present technique, a system is provided for processing search results. The system includes a classifier configured to obtain a standard classification for each document of a plurality of documents and to classify each document, based on the document's standard classification, into an interpretive classification within an interpretive classification system. The standard classification is a classification within a standard classification system while the interpretive classification comprises at least a primary class and a secondary class. The system further includes a search engine configured to search the plurality of documents based on a user input and to identify relevant documents, a processor configured to group the relevant documents into each relevant document's primary class and secondary class, and a display device configured to display the primary classes of the relevant documents and a number of relevant documents grouped in each displayed primary class.

### BRIEF DESCRIPTION OF THE DRAWINGS

FIG. 1 illustrates an example of search platform architecture.

FIG. 2 illustrates an example of a process for conducting a search and displaying search results.

FIG. 3 illustrates an example of a process for searching a patent collection.

FIG. 4 illustrates an example of a user interface.

FIG. 5 illustrates an example of a computing device.

### DETAILED DESCRIPTION

In the following description of preferred embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the preferred embodiments of the present invention.

This relates to a search platform that can facilitate efficient and intuitive perusal and analysis of search results. Additionally, the search platform can enable the user to easily narrow a result set of documents to focus on more relevant documents.

Although the exemplary embodiments are discussed with respect to a collection of patent documents, the search platform described can be applied to any collection of documents.

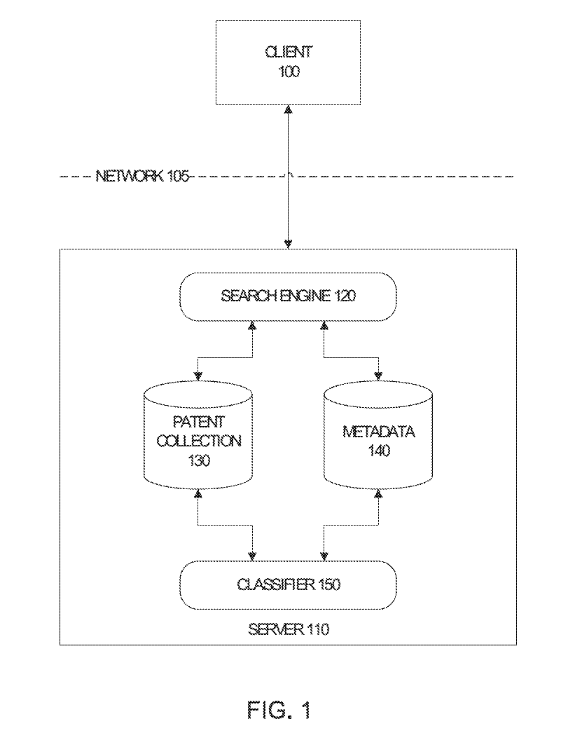

FIG. 1 illustrates an embodiment of exemplary search platform architecture. In the illustrated embodiment, client 100 can access server 110 across network 105. Server 110 can deploy search engine 120 and classifier 150, which can be associated with patent collection 130 and metadata 140.

Patent collection 130 can include one or more databases storing patent documents, such as patents and/or patent publications for example, associated with one or more national patent offices. Metadata 140 can include one or more databases storing data associated with the patent documents. The data can include bibliographic information, document vectors, classification information, summaries or abstracts, titles, claim terms, etc., related to the documents in the collection. The data can be organized in an index including a record for each document.

Although patent collection 130 and metadata 140 are shown as distinct databases in the embodiment illustrated in FIG. 1, in other embodiments the data embodied in patent collection 130 and metadata 140 can be stored together in one or more databases or other suitable storage medium.

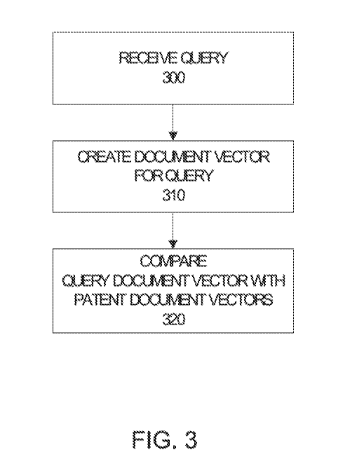

Search engine 120 can be based on any of numerous commercially available search engines. For example, in one embodiment, search engine 120 can be based on an enterprise search platform, such as the Fast Enterprise Search Platform by Microsoft Corp. A search engine can be programmed by one of ordinary skill in the art based on numerous search techniques. For example, a document vector search technique is discussed with respect to FIG. 3.

Classifier 150 can be used to analyze documents in patent collection 130 and to extract and/or create metadata 140. Classifier 150 can be a standalone unit or part of a larger unit with additional functionality. Classifier 150 can parse documents in patent collection 130 using known parsing techniques and extract or identify from the documents a standard classification.

A standard classification is a predetermined classification based on a standard system of classification. A standard system of classification is a system of classification that is accepted by at least some in a field of endeavor. The standard system of classification can be a classification system established by a governmental agency or a standard-setting organization, for example. In the context of patent documents, two examples of standard systems of classification are the International Patent Classification (IPC) system and the U.S. Patent Classification (USPC) system. The extracted/identified classification can be stored in metadata 140.

Classifier 150 can reclassify documents in patent collection 130 into an interpretive classification. An interpretive classification is a classification that is based on an interpretive system of classification. An interpretive system of classification can include more or fewer classifications than a standard system of classification. An interpretive classification includes at least one class and one subclass. An interpretive system of classification can consist of a larger or smaller hierarchy of classes and subclasses (i.e. class levels) than a standard system of classification. The number of classes at each level in the hierarchy can vary to provide the most user-friendly, intuitive hierarchy for enabling an ordinary searcher to quickly process and understand the breakdown of the hierarchy. Such a structure can allow the searcher to quickly narrow a large number of documents returned in a search to focus on the most relevant documents to the searcher. The names of classes and subclasses within an interpretive classification can be simpler, shorter, and/or more descriptive. Thus, an interpretive system of classification can be more user-friendly than a standard system of classification.

An interpretive system of classification can be designed to exploit the nature and characteristics of electronic searching and electronic display of relevant documents and their classifications. Specifically, graphical user interfaces provide various capabilities for providing an intuitive, user-friendly display of a class hierarchy through the use of tree elements, expansion buttons, and scroll buttons, for example. Also, links, information bubbles, and the like can be used to quickly and easily provide additional information regarding a class or subclass. As discussed in detail below, because the classes are displayed in conjunction with relevant documents identified relative to an input search term, the interpretive classification system can aid the searcher in ways that standard classification systems do not.

Classifier 150 can implement many different techniques for reclassifying documents into interpretive classifications. Classifier 150 can reclassify documents in patent collection 130 based on the standard classification of the documents. For instance, classifier 150 can consult a mapping between classifications in the standard system of classification and classifications in the interpretive system of classification. In an embodiment, classifier 150 can access other information regarding the documents from metadata 140, such as the title and claim terms, to aid in reclassification. In a further embodiment, classifier 150 can access document vectors of the documents to aid in reclassification.

In an embodiment, classifier 150 can reclassify a given document into multiple interpretive classifications. In reclassifying a document into multiple interpretive classifications, classifier 150 can select an interpretive classification that is mapped to the extracted standard classification but then could also select one or more other classifications based on terms in the document vector of the document. Weights of the terms, as discussed below, can be taken into consideration.

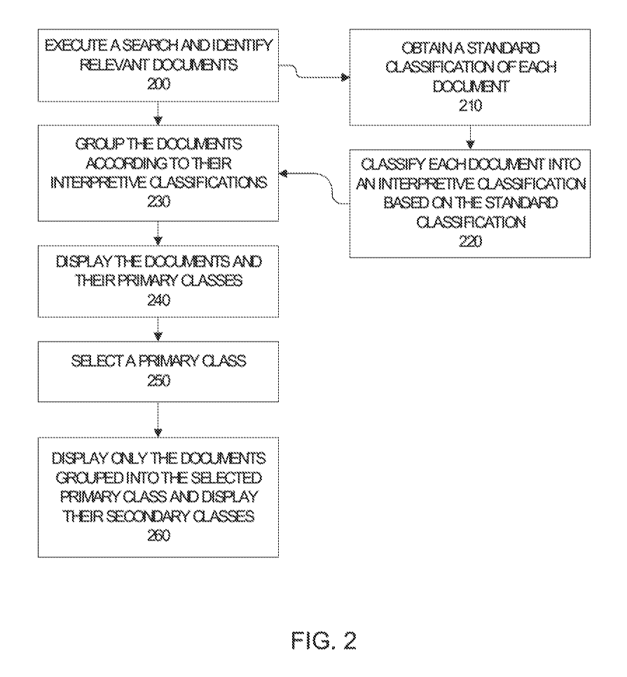

FIG. 2 illustrates an exemplary embodiment for conducting a search and displaying search results.

A search can be executed (block 200). The search can be based on an input entered by a user via an input element of a graphical user interface, for example.

The search can be executed by search engine 120 over patent collection 130. The ways in which search engine 120 can search a document collection can be myriad. FIG. 3 illustrates an embodiment in which search engine 120 can employ a vector based search methodology.

In using a vector based search methodology as illustrated in the embodiment of FIG. 3, upon receiving a query (block 300) search engine 120 can create (block 310) a document vector for the query. For example, the document vector can be a weighted list of words and phrases, such as:
[table, 1][chair, 0.5][plate, 0.2]
   as a simplified example. Once the query document vector is created, search engine 120 can compare (block 320) the query document vector with document vectors retrieved from patent collection 130 that have been previously created for each of the patent documents in patent collection 130. The document vectors can also be stored in metadata 140, such as in a record in the index corresponding to each document in patent collection 130. The comparison can include, for example, multiplying the weights of any common terms among the query document vector and the retrieved document vector, and adding the results to obtain a similarity ranking. Taking another simplified example:
query document vector: [table, 1][chair, 0.5][plate, 0.2]
retrieved document vector: [cup, 1][saucer, 0.7][chair, 0.6][plate, 0.5]
similarity=0.5*0.6+0.2*0.5=0.4
   If the similarity ranking exceeds a predefined threshold, search engine 120 can consider the patent document associated with the retrieved document vector to be a match. In other embodiments, rather than using a vector based search methodology, search engine 120 can utilize less dynamic search methodologies that do not involve the creation of document vectors for the patent documents.

In the vector based search methodology described above, each patent document stored in patent collection 130 can be associated with one or more document vectors. For example, since patent documents such as patents and patent publications usually have a defined number of sections for meeting statutory filing requirements, a distinct document vector can be created for various sections or combinations of sections of a patent document, enabling search engine 120 to tailor a search on specific sections of the patent document. Further, the document vectors can be adjusted to remove non-relevant words or phrases to yield a smaller and more concise document vector, which can improve efficiency of query processing due to time not spent by search engine 120 to process the removed strings.

After execution of the query, one or more documents can be identified as relevant to the input (block 200). The result set can be empty if no documents are deemed relevant to the input.

A standard classification of each relevant document can be obtained (block 210). The standard classification can be an IPC or USPC classification, as discussed previously. The standard classification can be obtained by classifier 150, for example, by processing the document on-the-fly. Alternatively, the standard classification can be obtained by consulting metadata 140 if the document has already been processed by classifier 150.

Each document can be reclassified into an interpretive classification (block 220). As discussed previously, the interpretive classification can be a classification in an interpretive classification system and can comprise a hierarchical structure including at least a primary class and a secondary class, but can further include additional subsidiary classes. The reclassification can occur on-the-fly after the search has been executed or it could have already been performed before the search was executed, and thus the interpretive classification can be stored in, and thus accessed from, metadata 140, for example.

In an embodiment, the functions of blocks 210 and 220 can be performed during database creation or updating. For instance, during database creation, classifier 150 can determine the standard classification of each document in patent collection 130 and store the classification in metadata 140. Classifier 150 can also classify the documents into an interpretive classification at database creation time or another time. The interpretive classification of each document can also be stored in metadata 140. Database creation includes adding additional documents to an already created database.

The relevant documents can be grouped according to their interpretive classifications (block 230). In particular, each document can be grouped into each class and subclass that comprises the document's classification. For instance, a grouping for a primary class COMPUTER could consist of all documents grouped in all of its subsidiary classes. A grouping denotes a stored association or relationship between a document and a class. The location of the document in a memory of a computer may not change as a result of the grouping. The number of documents in each grouping can be stored as well. In an embodiment where a document is reclassified into multiple interpretive classifications, that document can be grouped into the classes and subclasses of each of its interpretive classifications.

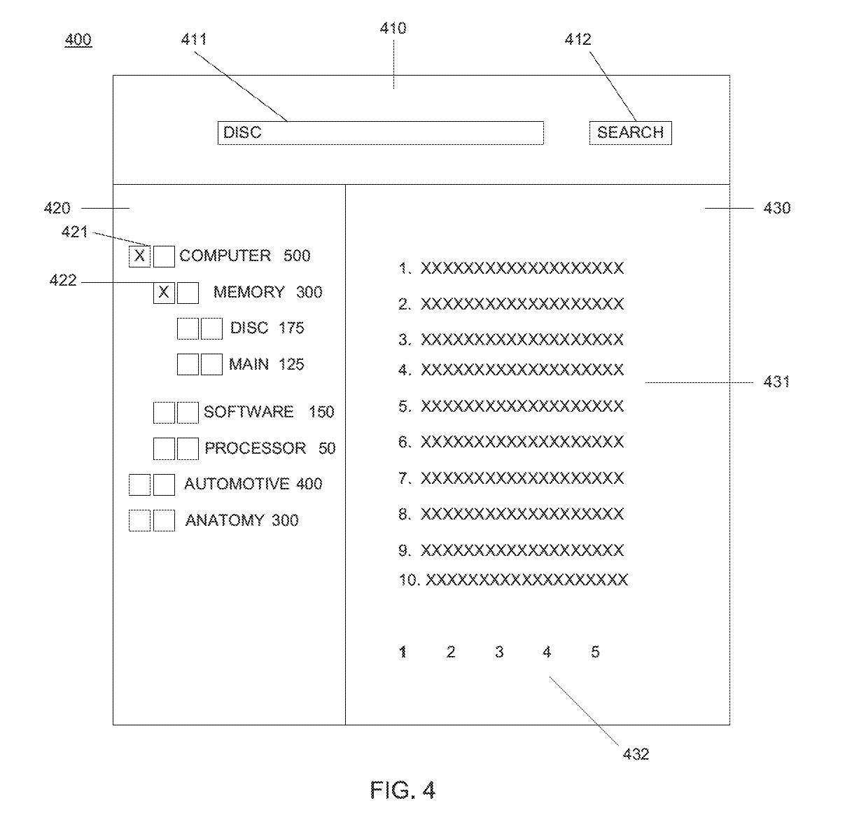

The relevant documents and their primary classes can be displayed (block 240). FIG. 4 depicts an exemplary graphical user interface 400 for displaying the relevant documents and the classes. User interface 400 can include a query section 410, a classification section 420, and a result section 430.

Query section 410 can include a text box 411 for entering an input and search button 412 for requesting execution of a search. In this example, the search term “DISC” has been entered into text box 411 and a search performed.

Classification section 420 can display the hierarchy of the interpretive classification system. The classes displayed correspond to classes of relevant documents identified by the search. In this simplified example, it is assumed that the search term “disc” could refer to a computer disc, a disc brake in a car, or a disc in the body. Thus, the primary classes displayed in this example are COMPUTER, AUTOMOTIVE, and ANATOMY, and all of the documents in the result set are classified into one of these primary classes.

The number of documents grouped in each class can be listed next to the class. Here, there are 500 documents grouped in COMPUTER, 400 documents grouped in AUTOMOTIVE, and 300 documents grouped in ANATOMY. The classes on a particular level of the hierarchy can be arranged in descending order with respect to the number of documents grouped in the class such that the class with the highest number of documents appears first. In a case where two or more classes on the same level have the same number of grouped documents, those classes can be displayed alphabetically. In the case of a large number of classes, a scroll button can be provided to permit a user to scroll through the classes. The hierarchy of the classes and checkboxes 421 and 422 are discussed below.

Displaying the primary classes of the relevant documents in this way allows a searcher to easily and quickly view the types of documents in the result set and their relationship to the original input, in this case “DISC”. If a searcher is interested in computer discs, the searcher can select the COMPUTER class, as discussed below, and thus reduce the number of relevant documents. In this case, if the documents each have only one interpretive classification, then the relevant documents would be reduced by more than half by selecting the COMPUTER class. In addition, further winnowing of the relevant documents can be performed by selecting subclasses.

Result section 430 can display document references of relevant documents. The document references can be displayed as a list 431 and can include relevant text of the document underneath the reference to enable a user to further ascertain the content of the document. The document references can be displayed in descending order of relevancy, as determined by the search engine. Depending on the size of a result set, additional pages of document references can be displayed on subsequent pages of result section 430 as indicated by buttons 432. A desired page can be selected via the buttons 432. In this example, there are five pages, as indicated by the five buttons.

A document reference can be a link. The document reference can link to a copy of the document stored in patent collection 130 of server 110. The document reference can also link to a copy of the document stored elsewhere in the world, such as a server of a patent office or a server local to client 100. Additionally, the document reference can link to a copy of the document stored on a local memory of client 100. In such an embodiment, a copy of the document can be transmitted to the client along with the result set. Thus, the document can be immediately available to a user upon viewing the result set. The time and processing power often required to reconnect to a server to retrieve a document specified in a result set can thus be eliminated.

A primary class can be selected (block 250), as discussed previously. A user can select one or more primary classes via classification section 420. Each class listed in classification section 420 has a selection checkbox (located to the left) and a deselection checkbox (located to the right). Selection and deselection boxes 421 correspond to primary class COMPUTER. Upon checking the selection box, the secondary classes of documents grouped into primary class COMPUTER can be displayed (block 260). In this example, the secondary classes include MEMORY, PROCESSOR, and SOFTWARE. Upon checking selection box 422 corresponding to MEMORY, the tertiary classes of documents grouped into secondary class MEMORY can be displayed (in this example, DISK and MAIN).

Upon selection of a class, the documents grouped into the selected class can be exclusively displayed (block 260). Result section 430 can thus be updated to display only the documents grouped into the selected class. By limiting the display of documents in result section to those in a selected class, a user can more quickly peruse those documents which are more likely to be relevant.

Upon deselection of a class, the documents grouped into the deselected class can be excluded from being displayed. Result section 430 can be updated accordingly. Thus, a deselection can have an effect on just the display of the documents within the deselected category. However, from the standpoint of result section 430, a selection of a class can have the effect of deselecting all other classes at that level. In an embodiment, classification section 420 is updated to display an ‘X’ in the checkboxes of each of the automatically deselected classes. Of course, a user can later choose to select a deselected class.

A selection or deselection can be reversed by clicking on the selection or deselection checkbox. By unselecting a checkbox of a selected class, the classification section 420 can be updated to collapse the subclasses (if any) of the now unselected class and the result section 430 can be updated to display the appropriate documents. For example, in FIG. 4, if the selection checkbox of the MEMORY class is unselected, result section 430 can be updated to display all documents grouped in the COMPUTER class. By unselecting a checkbox of a deselected class, result section 430 can be updated to display, in addition to the already displayed documents, the documents grouped in the deselected class.

In an embodiment, multiple classes at the same level in the class hierarchy can be selected at one time. Thus, for example, both the COMPUTER and AUTOMOTIVE primary classes can be selected by the user. In such a case, classification section 420 can display the secondary classes of each selected primary class. Also, result section 430 can display the documents grouped in each selected primary class. This feature can be useful, for example, if a searcher is interested in a teaching or feature that may be applicable to multiple technical fields.

A display-only feature can be provided when multiple classes and/or subclasses are selected at the same levels. A user can select display-only for a specific class and result section 430 can update to display only documents grouped in that class. The display-only feature can be a separate graphical user interface input element or can be instructed through some combination of a mouse or keyboard input, along with the selection checkbox of the desired class, for example. Such a feature can be useful if a searcher has selected multiple classes on the same level, especially at different levels of the class hierarchy, but desires to quickly view the documents grouped in only one specific class-subclass chain to see if a highly relevant document can be located.

The hierarchy displayed in classification section has subclasses indented with respect to immediately preceding classes. In an embodiment, the relationship between class and subclass can also be reflected using different colors, font sizes, text sizes, etc. Also, the checkboxes 421, 422 could be replaced with other graphical user interface elements. For example, the mere action clicking on a class with a mouse pointer could expand the class and thus serve as a selection. In short, there are many graphical user interface features that can be used to modify the exemplary user interface shown in FIG. 4, and one of ordinary skill in the art would readily recognize that such modification is possible and within the scope of the invention.

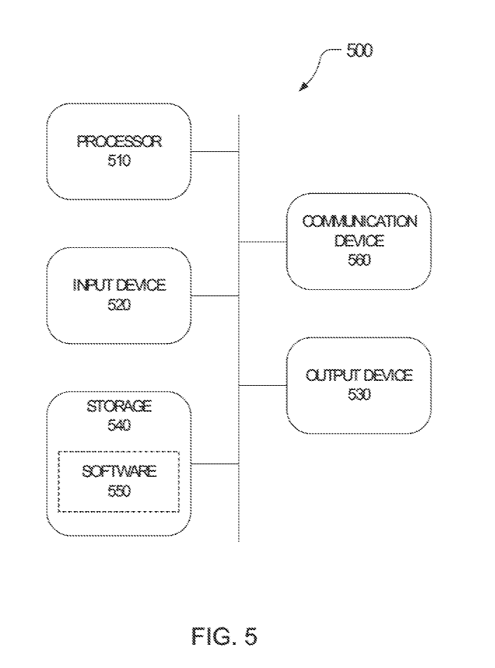

FIG. 5 shows a block diagram of an example of a computing device, which may generally correspond to client 100 and server 110. The form of computing device 500 may be widely varied. For example, computing device 500 can be a personal computer, workstation, server, handheld computing device, or any other suitable type of microprocessor-based device. Computing device 500 can include, for example, one or more components including processor 510, input device 520, output device 530, storage 540, and communication device 560. These components may be widely varied, and can be connected to each other in any suitable manner, such as via a physical bus, network line or wirelessly for example.

For example, input device 520 may include a keyboard, mouse, touch screen or monitor, voice-recognition device, or any other suitable device that provides input. Output device 530 may include, for example, a monitor or other display, printer, disk drive, speakers, or any other suitable device that provides output.

Storage 540 may include volatile and/or nonvolatile data storage, such as one or more electrical, magnetic or optical memories such as a RAM, cache, hard drive, CD-ROM drive, tape drive or removable storage disk for example. Communication device 560 may include, for example, a network interface card, modem or any other suitable device capable of transmitting and receiving signals over a network.

Network 105 may include any suitable interconnected communication system, such as a local area network (LAN) or wide area network (WAN) for example. Network 105 may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 550 can be stored in storage 540 and executed by processor 510, and may include, for example, programming that embodies the functionality described in the various embodiments of the present disclosure. The programming may take any suitable form. For example, as discussed previously, in one embodiment, programming embodying the patent collection search functionality of search engine 120 can be based on an enterprise search platform, such as the Fast Enterprise Search Platform by Microsoft Corp. for example.

Software 550 can also be stored and/or transported within any computer-readable storage medium for use by or in connection with an instruction execution system, apparatus, or device, such as computing device 500 for example, that can fetch instructions associated with the software from the instruction execution system, apparatus, or device and execute the instructions. In the context of this document, a computer-readable storage medium can be any medium, such as storage 540 for example, that can contain or store programming for use by or in connection with an instruction execution system, apparatus, or device.

Software 550 can also be propagated within any transport medium for use by or in connection with an instruction execution system, apparatus, or device, such as computing device 500 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method of processing search results, comprising:
executing a search based on a user input entered via a graphical user interface using a processor;
identifying relevant documents based on the search;
obtaining a standard classification for each relevant document, the standard classification being a classification within a standard classification system;
reclassifying each relevant document, based on the relevant document's standard classification, into an interpretive classification within an interpretive classification system, the interpretive classification comprising at least a primary class and a secondary class;
grouping the relevant documents into each relevant document's primary class and secondary class; and
displaying the primary classes of the relevant documents and a number of relevant documents grouped in each displayed primary class via the graphical user interface on a display device.

2. The method of claim 1, further comprising:
displaying the primary classes and the number of relevant documents grouped in each displayed primary class in a first portion of the graphical user interface; and
displaying the relevant documents in a second portion of the graphical user interface,
wherein the graphical user interface is configured to permit a selection or deselection of one or more classes.

3. The method of claim 2, further comprising:
receiving a selection of a displayed primary class;
updating the first portion of the graphical user interface to display the secondary classes of the relevant documents grouped into the selected primary class and a number of relevant documents grouped in each displayed secondary class; and
updating the second portion of the graphical user interface to display only the relevant documents grouped in the selected primary class.

4. The method of claim 3, further comprising:
receiving a selection of a displayed secondary class; and
updating the second portion of the graphical user interface to display only the relevant documents grouped in the selected secondary class.

5. The method of claim 4, wherein each interpretive classification comprises a tertiary class, the method further comprising:
grouping the relevant documents into each relevant document's tertiary class; and
updating the first portion of the graphical user interface to display the tertiary classes of the relevant documents grouped in the selected secondary class and a number of relevant documents grouped in each displayed tertiary class.

6. The method of claim 2, further comprising:
receiving a selection of two or more displayed primary classes;
updating the first portion of the graphical user interface to display the secondary classes of the relevant documents grouped in the selected two or more primary classes and a number of relevant documents grouped in each displayed secondary class; and
updating the second portion of the graphical user interface to display only the relevant documents grouped in the selected two or more primary classes.

7. The method of claim 2, further comprising:
receiving a deselection of one or more displayed primary classes;
updating the second portion of the graphical user interface to not display relevant documents grouped in the deselected one or more primary classes.

8. The method of claim 1, further comprising displaying the primary classes of the relevant documents in descending order with respect to the number of relevant documents grouped in each displayed primary class.

9. The method of claim 1, wherein the obtaining and reclassifying steps are performed during a database creation or update process, before the search is executed.

10. The method of claim 1, wherein each relevant document's interpretive classification comprises more class levels than the standard classification.

11. A system, comprising:
a classifier configured to obtain a standard classification for each document of a plurality of documents, the standard classification being a classification within a standard classification system, and to classify each document, based on the document's standard classification, into an interpretive classification within an interpretive classification system, the interpretive classification comprising at least a primary class and a secondary class;
a search engine configured to search the plurality of documents based on a user input and to identify relevant documents;
a processor configured to group the relevant documents into each relevant document's primary class and secondary class; and
a display device configured to display the primary classes of the relevant documents and a number of relevant documents grouped in each displayed primary class.

12. The system of claim 11, wherein:
the display device is further configured to display the primary classes and the number of relevant documents grouped in each displayed primary class in a first portion of a graphical user interface and to display the relevant documents in a second portion of the graphical user interface, and
the graphical user interface is configured to permit a selection or deselection of one or more classes.

13. The system of claim 12, wherein the display device is further configured to, upon receiving a selection of a displayed primary class, update the first portion of the graphical user interface to display the secondary classes of the relevant documents grouped in the selected primary class and a number of relevant documents grouped in each displayed secondary class, and update the second portion of the graphical user interface to display only the relevant documents grouped in the selected primary class.

14. The system of claim 13, wherein the display device is further configured to, upon receiving a selection of a displayed secondary class, update the second portion of the graphical user interface to display only the relevant documents grouped in the selected secondary class.

15. The system of claim 14, wherein each interpretive classification comprises a tertiary class, the processor is further configured to group the relevant documents into each relevant document's tertiary class, and the display device is further configured to update the first portion of the graphical user interface to display the tertiary classes of the relevant documents grouped in the selected secondary class and a number of relevant documents grouped in each displayed tertiary class.

16. The system of claim 12, wherein the display device is further configured to, upon receiving a selection of two or more displayed primary classes, update the first portion of the graphical user interface to display the secondary classes of the relevant documents grouped in the selected two or more primary classes and a number of relevant documents grouped in each displayed secondary class, and update the second portion of the graphical user interface to display only the relevant documents grouped in the selected two or more primary classes.

17. The system of claim 12, wherein the display device is further configured to, upon receiving a deselection of one or more displayed primary classes, update the second portion of the graphical user interface to not display relevant documents grouped in the deselected one or more primary classes.

18. The system of claim 11, wherein the display device is further configured to display the primary classes of the relevant documents in descending order with respect to the number of relevant documents grouped in each displayed primary class.

19. A computer-readable medium storing instructions to be executed by a computer, the stored instructions comprising:
executing a search based on a user input entered via a graphical user interface;
identifying relevant documents based on the search;
obtaining a standard classification for each relevant document, the standard classification being a classification within a standard classification system;
reclassifying each relevant document, based on the relevant document's standard classification, into an interpretive classification within an interpretive classification system, the interpretive classification comprising at least a primary class and a secondary class;
grouping the relevant documents into each relevant document's primary class and secondary class; and
displaying the primary classes of the relevant documents and a number of relevant documents grouped in each displayed primary class via the graphical user interface.

20. A system, comprising:
means for executing a search based on a user input entered via a graphical user interface;
means for identifying relevant documents based on the search;
means for obtaining a standard classification for each relevant document, the standard classification being a classification within a standard classification system;
means for reclassifying each relevant document, based on the relevant document's standard classification, into an interpretive classification within an interpretive classification system, the interpretive classification comprising at least a primary class and a secondary class;
means for grouping the relevant documents into each relevant document's primary class and secondary class; and
means for displaying the primary classes of the relevant documents and a number of relevant documents grouped in each displayed primary class via the graphical user interface.
